(19) United States
(12) Patent Application Publication
(10) Pub. No.: US 2003/0021873 A1
(43) Pub. Date: Jan. 30, 2003

(54) Calcium fortified shredded cheese with a calcium anti-caking agent

(75) Inventors: Richard E. Willits, Elkhart Lake, WI (US); John K. Brody, Plymouth, WI (US)

Correspondence Address: RYAN KROMHOLZ & MANION, S.C., POST OFFICE BOX 26618, MILWAUKEE, WI, 53226, US

(73) Assignee: Sargento Foods Inc.

(21) Appl. No.: 09/834,184

(22) Filed: Apr. 12, 2001

(51) Int. Cl. A23C 19/00

(52) U.S. Cl. 426/582

(57) ABSTRACT

A calcium fortified natural or pasteurized process divided cheese including an anti-caking agent which reduces the stickiness of the cheese and further provides calcium fortification of the product and method of manufacture. A powdered mixture for use on divided cheese as an anti-caking agent, calcium fortifier, and desiccation inhibitor.

### BACKGROUND OF THE INVENTION

Calcium fortification of products in the food industry, especially in the cheese industry, has been primarily directed to calcium fortification by direct addition of a calcium source to the cheese milk. The cheese milk is then used for manufacture of the various commercial cheese products, some of which include divided cheese products such as shredded or diced cheeses. Usually, calcium enriched, divided cheese products must be additionally treated with an anti-caking agent after dividing to prevent undesirable clumping of the product in the package. Typical anti-caking agents have been in the form of a cellulose powder which is a fibrous vegetable material, such as Keycel 2000 obtainable from International Fiber Corporation located in North Tonawanda, N.Y., U.S.A.

The present invention relates generally to a calcium enriched, divided cheese product and specifically to a calcium enriched anti-caking agent used on a divided cheese. Shredded cheese manufacture typically includes the step of adding an anti-caking agent such as cellulose powder to the already shredded cheese prior to packaging. Addition of an anti-caking agent to reduce the stickiness of the cheese is necessary to prevent the cheese shreds from clumping together in the package prior to use. Anti-caking agents have been used primarily to prevent undesirable clumping, yet leave the flavor and palatability of the cheese product unaffected. Presently, the usual anti-caking agent supplied to a shredded cheese product is cellulose, typically in micro-fine powder form. While the addition of cellulose powder has been successful in use as an anti-caking agent, it has been observed that cellulose does not add substantially to the food value of the finished product. Further, micro-fine cellulose adds appreciable dust particles to the production environment and may contribute to leaky packages, due to product being caught in the package profile during sealing and filling. Additionally, cellulose coated divided cheese often develops an unacceptable desiccated appearance prior to purchase that consumers find unappealing.

### SUMMARY OF THE INVENTION

The present invention seeks to ameliorate the shortcomings associated with cellulose anti-caking agents while additionally enriching the divided cheese product, whereby food value in the form of calcium fortification is added.

Also, the present invention is a unique and simple process and does not require the use of special or additional filling or sealing apparatus to practice the invention.

This invention relates to the fortification of a divided cheese, such as diced or shredded cheese, wherein the fortification additionally imparts an anti-caking characteristic to the divided cheese product. Further, the fortification has been observed to lessen the desiccation of the product over time. In the present invention, a powdered calcium, such as calcium carbonate or calcium sulfate is added to the cheese after it has been shredded. Acceptable calciums include calcium sulfate, such as anhydrous calcium sulfate which may be obtained from the United States Gypsum Co., by the name of “Snow White”; dihydrate calcium sulfate, which may be obtained from the United States Gypsum Co., by the name of “Terra Alba”, or calcium carbonate, although it is to be understood that other calciums could be used. Addition of a calcium, such as one of these reduces clumping of the product in the package prior to use, while adding nutritional value to the product in the form of calcium fortification. The calcium may be substituted for the cellulose powder currently in use for anti-caking, or a predetermined percentage of the cellulose may be replaced by calcium. Addition of calcium to the shredded cheese allows the manufacturer to use a smaller quantity of traditional anti-caking agent, as the total amount of traditional anti-caking agent may be reduced at the rate calcium is added. Since calcium is typically less expensive than cellulose powder, a manufacturer may also benefit from a cost savings. Alternatively, a starch may be combined with a calcium with similar results. While the present invention contemplates the use of potato starch, other starches may be used, such as that from rice, wheat, corn and tapioca. Potato starch used in this embodiment may further include amounts of cellulose as a flow agent such as that obtained commercially as Free Flow 102 from Allied Starch and Chemical, or alternatively, the starch may be blended directly with the calcium.

According to the present invention, an anti-caking agent is formed of a calcium, a mixture of calcium and cellulose powder, a mixture of starch such as potato starch, cellulose and a calcium, or a mixture of starch, and a calcium. The agent is applied to the cheese product after the cheese has been divided (e.g. shredded or diced). A blend of calcium with starch or cellulose as an anti-caking agent enables the level of calcium in cheese shreds to rise above 300 mg per ounce. The anti-caking blends proposed by the present invention are less expensive than traditional cellulose powder used by itself, and additionally raise the level of calcium in the finished product. The blends of the present invention create less dust than conventional cellulose used alone and additionally reduce the number of leaky package rejections during production. Furthermore, taste tests made using the blends of the present invention indicate a preference for the blends of the present invention over the current, cellulose-only product. Also, the blends of the present invention decrease desiccation of the packaged product prior to consumer purchase, thereby improving the visual appearance of the product in the retail setting. An additional benefit of the blends of the present invention is the reduced cost of the blended anti-caking product as compared to the traditional use of cellulose powder, such as Keycel 2000.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

The present invention is directed to an improved anti-caking agent for use on divided cheese, such as shredded or diced, natural or pasteurized process cheese. Anti-caking formulas have been developed that combine a calcium in various combinations with cellulose powder, starch, or cellulose powder and starch. While it is presently preferred that potato starch be used, it is to be understood that other starches such as those from rice, wheat, corn and tapioca may also be used. By appropriate selection and mixture of these components, a novel anti-caking agent is produced. Use of the improved mixtures of the present invention imparts calcium enrichment and anti-caking properties to the cheese, as well as improving the shelf appearance of the product by decreasing in-package desiccation. The calcium to be used may be calcium sulfate, such as an hydrous calcium sulfate which may be obtained from the United States Gypsum Co., by the name of “Snow White”; dihydrate calcium sulfate, which may be obtained from the United States Gypsum Co., by the name of “Terra Alba”, or calcium carbonate, although this list is not meant to be exhaustive. The preferred ingredients are milled to fine sieve size. Use of a calcium not only provides excellent anti-caking characteristics, but also provides a source of calcium fortification for the cheese. Further, it has been observed that addition of calcium to cellulose powder reduces the airborne dust usually encountered by use of cellulose by itself. The addition of a calcium with either cellulose or potato starch and cellulose forms an anti-caking agent that exhibits good flow properties during application and improves the visual impression of the product. Further, the in-package appearance is improved as the appearance of desiccation is reduced.

The following examples illustrate the novelty of the new anti-caking agent and are not intended to limit the invention:

### EXAMPLE 1

Divided natural or pasteurized process cheese is prepared using an Urschel Cheese Shredder, or other conventional means, set for the production of divided cheese having predetermined shape and dimensions. The dividing process takes place at a temperature of between 35° F.-50° F. The divided cheese members are subjected to an anti-caking agent of the present invention by way of Schenck Accurate Gravimetric Feeder and further tumbled in a stainless steel tumbler. Anti-caking agent is added such that its final application is approximately 2% of the final product weight, or about 4.5 g per 227 g of cheese.

The divided cheese blended with the anti-caking agent is loaded in a Form Fill and Seal Machine for packaging.

### EXAMPLE 2

This example was designed to compare the effectiveness of calcium carbonate as an anti-caking agent to an anti-caking agent composed of straight cellulose and a control having no anti-caking agent applied. Both anti-caking agents were applied at the rate of 1.0% and 2.0% by weight onto freshly shredded mild Cheddar cheese. The treated cheese was placed in cheese bags using 150 grams of cheese per bag. The cellulose product used was Keycel 2000. The results are presented in Table 1.

TABLE 1

| | Anti-caking | Anti-caking | Taste and |
|---|---|---|---|
| No. | Formula Used | Properties | Mouth Feel |
| 1 | 2.0% Keycel | No clumping | Excellent |
| | 2000 | of cheese | |
| | Cellulose | observed. | |
| | Powder | | |
| 2 | 2.0% Calcium | No clumping | Excellent |
| | Carbonate | of cheese | |
| | Powder | observed. | |
| 3 | 1.0% Keycel | Slight | Excellent |
| | 2000 | clumping of | |
| | Cellulose | cheese | |
| | Powder | observed. | |
| 4 | 1.0% Calcium | No clumping | Excellent |
| | Carbonate | of cheese | |
| | Powder | observed. | |
| 5 | None | Definite | Same as |
| | | clumping of | numbers 1- |
| | | cheese | 4, inclusive |
| | | observed. | |

The results clearly show that the use of calcium carbonate powder as an anti-caking agent was not noticeably different from the Keycel 2000 cellulose product, but additionally contributed calcium enrichment to the cheese product. Further, the lower, 1% application rate produced a better anti-caking result using the calcium carbonate than the cellulose powder. Use of calcium carbonate as the anti-caking agent fortified the cheese with calcium. A 1% addition of calcium carbonate to the cheese increases the calcium level in the resultant product by 56%.

Although calcium carbonate was used in this example, it is to be understood that other calciums could be used, such as calcium sulfate.

### EXAMPLE 3

This example was designed to compare the effectiveness of different blends of calcium carbonate and cellulose powder to determine the percentage of calcium carbonate that may be blended with cellulose and yet provide proper flow and dispersion onto the divided cheese. The anti-caking blends were pre-blended prior to being added to the dispenser and were added at a flow rate of 6.5 dispenser flow speed. 100% cellulose powder in the form of Keycel 2000 was used as the control. The powder was applied to shredded mild Cheddar cheese. The results are presented in Table 2.

TABLE 2

| | | Flow Property in |
|---|---|---|
| No. | Blend | Dispenser |
| 1 | 90% calcium carbonate/10% | Flowed through the |
| | cellulose powder | dispenser freely |
| 2 | 60% calcium carbonate/40% | Flowed through the |
| | cellulose powder | dispenser freely |
| 3 | 100% cellulose powder | Flowed through the |
| | | dispenser freely |

The results show that addition of calcium carbonate to the cellulose powder does not affect the flow property through the dispenser. Proper flow and even dispersion was maintained in all test rates.

### EXAMPLE 4

This example was designed to investigate whether potato starch may be used as an anti-caking agent to replace the cellulose powder, yet maintain proper flow and even dispersion on the cheese shreds. The potato starch was substituted for cellulose powder and applied at different flow rates to shredded mild Cheddar cheese. 100% cellulose powder was used as the control. The results are presented in Table 3.

TABLE 3

| | | Blend Content | Visual Appearance |
|---|---|---|---|
| No. | Blend | on Product | Of Cheese and Flow Property |
| 1 | 100% | 0.8% | Insufficient amount to |
| | potato | | achieve satisfactory flow |
| | starch | | through packaging equipment. |
| | | | Cheese exhibited unacceptable |
| | | | level of clumping. |
| 2 | 100% | 1.3% | Excellent distribution and |
| | potato | | flow through packaging |
| | starch | | equipment. |
| 3 | 100% | 2.1% | Good distribution and flow |
| | potato | | through packaging equipment. |
| | starch | | |
| 4 | 100% | 2.7% | Very good distribution and |
| | potato | | flow through packaging |
| | starch | | equipment. |
| 5 | 60% | 1.7% | Good distribution and flow |
| | calcium | | through packaging equipment. |
| | carbonate | | |
| | and 40% | | |
| | potato | | |
| | starch | | |
| 6 | 60% | 5.5% | Poor flow through packaging |
| | calcium | | equipment and uneven |
| | carbonate | | distribution on cheese. |
| | and 40% | | |
| | potato | | |
| | starch | | |
| 7 | 60% calcium | 1.8% | Very good distribution and |
| | carbonate | | flow through packaging |
| | and 40% | | equipment. |
| | cellulose | | |
| 8 | 100% | 1.0% | Good distribution and flow |
| | cellulose | | through dispenser and through |
| | | | packaging equipment. |
| 9 | 100% | 1.3% | Very good distribution and |
| | cellulose | | flow through packaging |
| | | | equipment. |

The results show that when the potato starch is applied at a higher level than that of the cellulose, the potato starch performed well. The calcium carbonate/potato starch blend performed well at the 1.7% level.

### EXAMPLE 5

This example was designed to compare consumer acceptability of potato starch as an anti-caking agent to a control having an anti-caking agent composed of 100% cellulose powder in the form of Keycel 2000. Six consumer acceptability characteristics were used in the comparison to determine the overall consumer acceptability of potato starch as an anti-caking substitute for cellulose. The cellulose was applied at a 1.3% level to shredded mild Cheddar cheese. The potato starch was applied at a 2.7% level to shredded mild Cheddar cheese. The potato starch used may be obtained from Allied Starch and Chemical and sold under the name Free Flow 102. The test was repeated using cold samples of 0.75 ounces of cheese, and hot treatment in the form of 1 cup of cheese heated in the microwave for one minute and prepared as a quesadilla. The samples were served sequential monadically in a randomized order. A six-inch line was used, where 6 equals “like extremely.” The results are presented in Table 4.

TABLE 4

| | | | | Texture | Texture | |
|---|---|---|---|---|---|---|
| Product | Appearance | Flavor | Aftertaste | Smooth | Moist | Overall |
| 1. cold | 4.3 | 4.0 | 3.7 | 3.9 | 3.7 | 3.9 |
| control | | | | | | |
| 2. cold | 4.2 | 4.1 | 3.9 | 3.8 | 3.4 | 4.1 |
| test | | | | | | |
| 3. hot | 4.0 | 4.3 | 4.3 | 4.3 | 3.8 | 4.2 |
| control | | | | | | |
| 4. hot | 3.8 | 4.0 | 4.2 | 4.1 | 4.2 | 4.0 |
| test | | | | | | |

The results show that no significant preferences exist in the samples.

### EXAMPLE 6

This example was designed to compare consumer acceptability of a calcium carbonate and potato starch blend as an anti-caking agent to a control having an anti-caking agent composed of 100% cellulose. Six consumer acceptability characteristics were used to determine the overall consumer acceptability of the blend as an anti-caking substitute for cellulose. Cellulose, in the form of Keycel 2000, was applied at a 1.3% level to shredded mild Cheddar cheese. The blend was prepared as 60% calcium carbonate and 40% potato starch and applied at a 1.7% level to shredded mild Cheddar cheese.

The test was repeated using both cold and hot samples. The cold sample contained 0.75 ounces of cheese. Quesadillas were served for the hot treatment. Each quesadilla was prepared with one cup of cheese and heated in a microwave oven for one minute. The samples were served sequential monadically in a randomized order. A six-inch line was used, where 6 equals “like extremely.” The test was analyzed at the 95 percent confidence level. The results are presented in Table 5.

TABLE 5

| | | | | Texture | Texture | |
|---|---|---|---|---|---|---|
| Product | Appearance | Flavor | Aftertaste | Smooth | Moist | Overall |
| 1. cold | 3.8 | 3.7 | 4.0 | 3.7 | 3.4 | 3.8 |
| control | | | | | | |
| 2. cold | 4.6 | 4.2 | 4.0 | 4.0 | 4.0 | 4.1 |
| test | | | | | | |
| 3. hot | 4.2 | 4.2 | 4.1 | 4.5 | 4.0 | 4.2 |
| control | | | | | | |
| 4. hot | 4.3 | 4.5 | 4.6 | 4.7 | 4.1 | 4.5 |
| test | | | | | | |

The results show that while there were no significant differences or preferences in products 3 and 4, there was a significant appearance preference in products 1 and 2. The test product 2 was perceived as having a more natural, preferred appearance.

It is to be understood that although calcium carbonate was used in the examples, it is conceivable that other acceptable calciums, such as calcium sulfate may be used. It is also be understood that although the examples illustrate the novel anti-caking agent as applied to shredded mild Cheddar cheese, other forms of divided cheeses, such as diced cheeses, may benefit from the anti-caking agents disclosed herein. Additionally, it is contemplated that the anti-caking agent of the present invention may be applied to other varieties of divided cheeses, including, but not limited to, Mozzarella, Colby, Swiss, Monterey Jack, Edam, Provolone, Romano, Parmesan, Gouda, Asiago, Emmenthal, or a mixture of these.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A method of treating a divided cheese product for anti-caking and calcium enrichment, comprising the steps of:
providing a divided cheese;
applying a powdered calcium to said divided cheese.

2. The method of claim 1 further including the step of applying powdered cellulose to said divided cheese.

3. The method of claim 1 further including the step of applying starch to said divided cheese.

4. The method of claim 3, wherein said starch is selected from the group consisting of rice, wheat, potato, tapioca and corn-, or mixtures thereof.

5. The method of claim 1, wherein said divided cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

6. A method of treating a divided cheese product for anti-caking and calcium enrichment, comprising the steps of:
providing a divided cheese;
applying a powdered calcium carbonate to said divided cheese.

7. The method of claim 6 further including the step of applying powdered cellulose to said divided cheese.

8. The method of claim 6 further including the step of applying starch to said divided cheese.

9. The method of claim 8 wherein said starch is selected from the group consisting of rice, wheat, potato, tapioca and corn, or mixtures thereof.

10. The method of claim 6, wherein said divided cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

11. A method of treating a divided cheese product for anti-caking and calcium enrichment, comprising the steps of:
providing a divided cheese product;
applying a powdered calcium sulfate to said divided cheese product.

12. The method of claim 11 further including the step of applying powdered cellulose to said divided cheese product.

13. The method of claim 11 further including the step of applying starch to said divided cheese product.

14. The method of claim 13, wherein said starch is selected from the group consisting of rice, wheat, potato, tapioca and corn, or mixtures thereof.

15. The method of claim 11, wherein said divided cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

16. A method of manufacturing an enriched divided cheese product comprising the steps of:
providing a divided cheese product;
applying to said divided cheese product a powdered calcium.

17. A method of treating a divided cheese product for anti-caking and calcium enrichment, comprising the steps of:
providing a divided cheese product;
applying a powdered mixture of cellulose and calcium to said divided cheese product.

18. The method of claim 17 wherein said powdered mixture is a blend having a ratio of least one part calcium powder to one part cellulose powder.

19. A method of treating a divided cheese product for anti-caking and calcium enrichment, comprising the steps of:
providing a divided cheese product;
applying a powdered mixture of potato starch and calcium to said divided cheese product.

20. The method of claim 19 wherein said powdered mixture is a blend containing at least 25% calcium.

21. A calcium enriched divided cheese produced in accordance with the method of claim 1.

22. A calcium enriched divided cheese produced in accordance with the method of claim 6.

23. A calcium enriched divided cheese produced in accordance with the method of claim 11.

24. A cheese product produced in accordance with the method of claim 16.

25.A cheese product produced in accordance with the method of claim 17.

26. A cheese product comprising:
a divided cheese; and
a coating of powdered calcium deposited on the divided cheese.

27. The cheese product of claim 26 wherein said divided cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

28. The cheese product of claim 26 wherein said powdered calcium is calcium carbonate.

29. The cheese product of claim 26 wherein said powdered calcium is calcium sulfate.

30. A cheese product comprising:
a divided cheese; and
a coating of powdered calcium and cellulose deposited on the divided cheese.

31. The cheese product of claim 30 wherein said divided cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

32. The cheese product of claim 30 wherein said powdered calcium is calcium carbonate.

33. The cheese product of claim 30 wherein said powdered calcium is calcium sulfate.

34. A cheese product comprising:
a divided cheese; and
a coating of powdered calcium and potato starch deposited on the divided cheese.

35. The cheese product of claim 34 wherein said powdered calcium is calcium carbonate.

36. The cheese product of claim 34 wherein said powdered calcium is calcium sulfate.

37. The cheese product of claim 34 wherein said divided cheese is selected form the group consisting of Mozzarella, Cheddar, Colby, Swiss, Monterey Jack, Edam, Romano, Parmesan, Asiago, Emmenthal, Gouda and Provolone cheeses, or mixtures thereof.

38. An anti-caking agent comprising:
a powdered calcium.

39. The anti-caking agent of claim 38 wherein said powdered calcium is in the form of calcium carbonate.

40. The anti-caking agent of claim 38 wherein said powdered calcium is in the form of calcium sulfate.

41. The anti-caking agent of claim 38 further comprising powdered cellulose.

42. The anti-caking agent of claim 38 further comprising potato starch.

43. An anti-caking agent for cheese comprising:
a powdered calcium.

44. A method of treating a divided cheese product for anti-caking comprising the steps of:
providing a divided cheese;
applying a mixture of powdered calcium carbonate
and powdered cellulose to said divided cheese
wherein said mixture is at least 25% calcium.

45. A method of treating a divided cheese product for anti-caking comprising the steps of:
providing a divided cheese;
applying a mixture of powdered calcium carbonate
and potato starch to said divided cheese wherein
said mixture is at least 25% calcium.

46. A method of treating a divided cheese product for anti-caking comprising the steps of:
providing a divided cheese;
applying a mixture of powdered calcium sulfate
and powdered cellulose to said divided cheese
wherein said mixture is at least 25% calcium.

47. A method of treating a divided cheese product for anti-caking comprising the steps of:
providing a divided cheese;
applying a mixture of powdered calcium sulfate and potato starch to said divided cheese wherein
said mixture is at least 25% calcium.

48. A method of treating a divided cheese product for anti-caking comprising the steps of:
providing a divided cheese;
applying a mixture of powdered calcium carbonate and powdered cellulose to said divided cheese wherein said mixture is at least 25% calcium, and wherein said cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

49. A method of treating a divided cheese product for anti-caking comprising the steps of:
providing a divided cheese;
applying a mixture of powdered calcium carbonate and potato starch to said divided cheese wherein said mixture is at least 25% calcium, and wherein said cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

50. A method of treating a divided cheese product for anti-caking comprising the steps of:
providing a divided cheese;
applying a mixture of powdered calcium sulfate and powdered cellulose to said divided cheese wherein said mixture is at least 25% calcium, and wherein said cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.

51. A method of treating a divided cheese product for anti-caking comprising the steps of:
providing a divided cheese;
applying a mixture of powdered calcium sulfate and potato starch to said divided cheese wherein said mixture is at least 25% calcium, and wherein said cheese is selected from the group consisting of Mozzarella, Cheddar, Colby, Swiss, Monterey Jack, Edam, Romano, Parmesan, Asiago, Emmenthal, Gouda and Provolone cheeses, or mixtures thereof.
